(19) United States
(12) Patent Application Publication
(10) Pub. No.: US 2018/0106362 A1
(43) Pub. Date: Apr. 19, 2018

(54) MODE SELECTION DEVICE FOR A VEHICLE GEARBOX WITH SLEDGE MECHANISM

(71) Applicant: PREH GMBH, Bad Neustadt a. d. Saale (DE)

(72) Inventors: Harald SCHELBERT, Gemunden (DE); Maximilian TÜRPITZ, Grosseibstadt (DE); Matthias BLUM, Zella-Mehlis (DE)

(73) Assignee: PREH GMBH, Bad Neustadt a. d. Saale (DE)

(21) Appl. No.: 15/718,479

(22) Filed: Sep. 28, 2017

(30) Foreign Application Priority Data
Oct. 18, 2016 (DE) 10 2016 119 842.0

(51) Int. Cl. F16H 59/10

(52) U.S. Cl. CPC F16H 59/105; F16H 2059/0295

(57) ABSTRACT

A mode selection device for a vehicle gearbox, including a guide part, a sledge, a housing and a handle attached to the sledge, wherein the sledge is movable by the handle along a guide path of the guide part in the same adjustment direction as the respective handle into predetermined longitudinal positions, wherein the guide part is pivotably mounted at the housing around a pivot direction perpendicular to the adjustment direction, so that the handle is movable in predetermined pivot positions, wherein the predetermined pivot positions and longitudinal positions of the handle correspond to a predetermined mode of operation of the vehicle gear.

### CROSS-REFERENCE TO RELATED APPLICATIONS

This application claims priority to the German Application No. 102016119842.0, filed Oct. 18, 2016, now pending, the contents of which are hereby incorporated by reference.

### TECHNICAL FIELD

The present disclosure relates to a mode selection device for a vehicle gear-box, especially for a vehicle gearbox having a variable transmission that is adjustable by a control device.

### BACKGROUND

Known mode selection devices, also called gear selectors, comprise a lever having a handle attached thereto, wherein the lever is mounted to a housing by a cardan joint or a ball joint. Such mode selection devices have a comparably bulky design, and have the disadvantage that different haptic feedback corresponding to the respective movement directions is difficult to be realized.

In view of this background, there has been a need for a solution providing a mode selection device having a high level of integration, especially wherein the haptic feedback thereof, in relation to the different operating directions, may more easily be customized or may easily be specified by construction measures.

### SUMMARY

This object will be solved by a mode selection devices according to claim 1. An equally advantageous use is the subject matter of the use claim. Advantageous embodiments are the subject matter of the respective dependent claims. It is to be noted that the features individually set forth in the claims may be combined with each other in any technologically reasonable way giving rise to further embodiments of the present disclosure. The description, especially in connection with the figures, additionally characterizes and specifies the present disclosure.

The present disclosure relates to a mode selection device for a vehicle gearbox, for example for the adjustment of the drive positions of an automatic transmission of a vehicle. It is preferably a vehicle gearbox having electromechanical means for the adjustment of the gear levels of the vehicle gear. The mode selection device comprises a guiding part, a sledge, a housing, and a handle attached to sledge. According to the present disclosure, the sledge, while being manually operated by the handle, is movable along at least one guide path of the guide part, in the same adjustment direction as the respective handle, into predetermined longitudinal positions. Moreover, according to the present disclosure, the guide part is pivotably supported to the housing in a pivot direction perpendicular to the adjustment direction, or in other words, is pivotably supported around a pivot axis parallel to the adjustment direction, so that the handle is movable to predetermined pivot positions, wherein the predetermined pivot positions and longitudinal positions of the handle correspond to a predetermined mode of operation of the vehicle gear. By way of the differently configured mechanisms according to the present disclosure, on the one hand by way of the sledge mechanism provided for the displacement in the adjustment direction, and on the other hand by way of the pivot mechanism provided for the pivoting action in pivot direction, a haptic feedback depending of the direction of both of the operating directions and at the same time being a different haptic feedback is easily to be realized. Moreover, such a configuration occupies a comparably low construction volume in relation to conventional joints.

The different predetermined positions of the handle, comprised of a combination of a predetermined pivot position and a longitudinal position, are for example detected by electrical or electro-mechanical detection means, especially by contactless detecting detection means, such as optical or magnetic detection means.

According to one embodiment, the guide path is rectilinearly configured, preferably the guide path is constantly bent. For example, the guide path is bent away from the handle. For example, the radius of curvature describing the curvature crosses an area segment and the handle is arranged outside of this area segment. The constant curvature allows to predetermine a movement of the handle, which, for example, is better adapted to the seating position of the user and to the relative position of user and handle. For example, the at least one guide path is bent, such that movement of the handle in adjustment direction into an end position of the handle distant from the user results in a relative raise of the handle. In another embodiment, it is provided that that the curvature is formed approximately or exactly circular to prescribe a movement of the handle during displacement in the adjustment direction, which approximately or exactly corresponds to a movement as it results from a conventional gear selector, such as a cardanically mounted gear.

It is preferably provided that a maximally possible adjustment path corresponding to the adjustment direction is longer than a maximally possible pivot path corresponding to the pivot direction. In other words, the handle may be displaced to a larger extend than it can be pivoted in the pivot direction perpendicular to the adjustment direction.

According to one embodiment, a gear having rotational damper is provided between the sledge and the guide part. For example, the rotational damper comprises a housing that defines a chamber filled with a viscous fluid, for example silicone oil, a rotor that is rotatably mounted in the chamber and is driven by the gearbox through the handle and movable valve means that are arranged in the cylindrical housing for the adjustment of flow of the viscous fluid in the chamber. Through the rotational damper, a resistance force may counteract the displacement, the resistance determining the haptic feedback during displacement in the adjustment direction.

One embodiment of the mode selection device according to the present disclosure comprises a gate, which defines the predetermined pivot positions and longitudinal positions. For example, the gate comprises one or more longitudinal shift channels extending along the adjustment direction and at least one transversal shift channel connecting the longitudinal shift channels and extending in pivot direction, and/or at least one transversal shift channel solely leading into one longitudinal shift channel and also extending in pivot direction.

Preferably, the gate comprises several longitudinal shift channels extending in the adjustment direction, which are arranged offset to each other in the adjustment direction. Preferably, the several longitudinal shift channels differ in their length defining the adjustment path in the adjustment direction.

Preferably, engaging means are additionally provided to engagingly set the handle in one of the predetermined adjustment positions and/or one of the pivot positions. For example, the engaging means are provided at the gate.

According to another embodiment, return means are furthermore provided to independently return the guide part and thus the sledge and the handle into the neutral position in the opposite direction following manual displacement in the pivot direction.

Preferably, the return means include a multi-leg spring, for example a leaf spring or a wire spring. Preferably, the multi-leg spring is fixed, for example via a central portion, at the housing and is arranged such that the legs thereof, for example the outer terminal legs thereof, returningly act onto the guide part in two opposite directions.

In another embodiment, the return means include at least one pair of permanent magnets, thereby providing a wear-free solution, which in addition allows provision of a specific haptic feedback by way of appropriately arranging and pairing the magnets.

The present disclosure furthermore relates to the use of the mode selection device according to the present disclosure in one of its above-described embodiments in a motor vehicle for operational mode selection of a gearbox of the motor vehicle, for example of a drive gearbox. For example, the mode selection device is incorporated in a center console of the motor vehicle or is incorporated in an armrest of a vehicle seat. Preferably, the mode selection device according to the present disclosure is made use of in a traction engine for agricultural or municipal utilization or a forestry machine.

The present disclosure will be further explained by way of the following figures. The figures are to be understood only as examples solely representing certain embodiments.

### BRIEF DESCRIPTION OF THE DRAWINGS

FIG. 1 is a perspective view of an embodiment of the mode selection device according to the present disclosure.

FIG. 2 is a sectional view across the mode selection device of FIG. 1.

FIG. 3 is a perspective view of a detail of the mode selection device according to the present disclosure of FIG. 1.

FIG. 4 is a perspective view of different pivot positions of the mode selection device of FIG. 1.

FIG. 5 is a perspective detailed view of another embodiment of the mode selection device according to the present disclosure.

### DETAILED DESCRIPTION

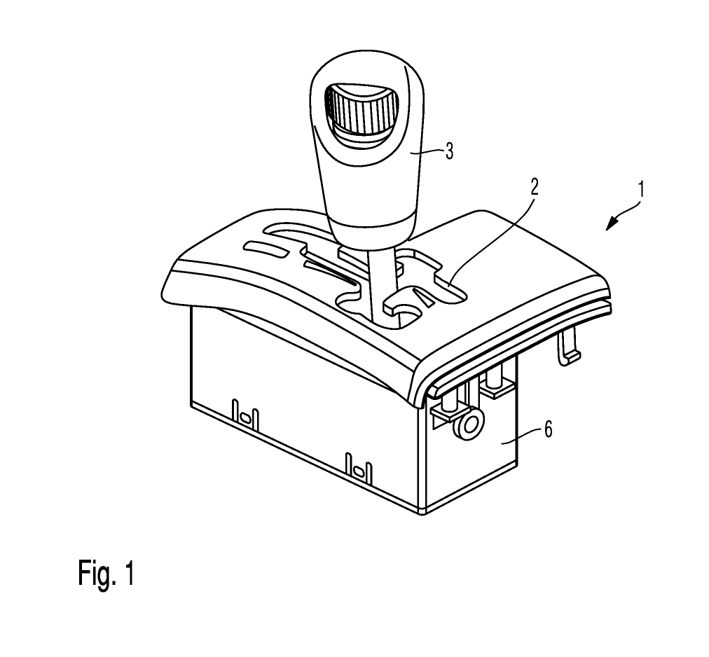

FIG. 1, in perspective representation, shows a first embodiment of the mode selection device 1 according to the present disclosure, also briefly called gear selector. This comprises a housing 6 and a handle 3 movably mounted on the housing 6. The degrees of freedom of movement of the handle 3 are limited by a gate 2, the gate 2 especially defining several longitudinal shift channels of different length which are arranged mutually offset. The transversal shift channels lead into the longitudinal shift channels for connecting them, thereby being able to displace the handle 3 from a longitudinal shift channel into a neighboring longitudinal shift channel. The movement the handle 3 along the longitudinal shift channel is referred to as adjustment movement and is performed in the adjustment direction, whereas the movement of the handle 3 along the transversal shift channel is referred to as pivot movement and is performed in the pivot direction.

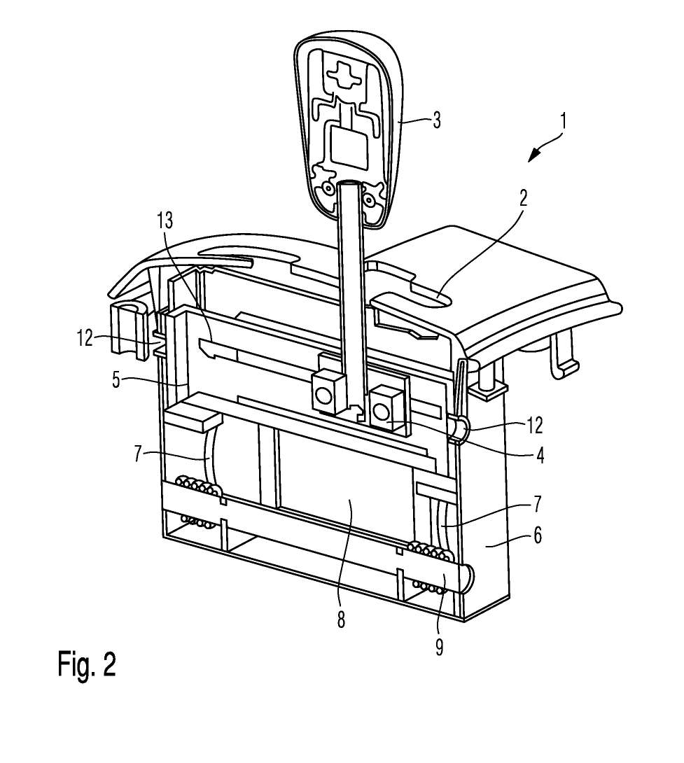

The mechanism that is provided for each of these movements will be explained in detail by way of FIG. 2. The handle 3 is rigidly connected to a sledge 4. The sledge 4 is movably guided along a linear guide path 13 in the form of an elongated hole in a guide part 5 and, by way of the handle 3, is displaceable along this guide path 13. The guide part 5 comprises components of plastics, aluminum and/or metal alloy, such as ZAMAK. The guide part 5 is pivotably mounted on the housing 6 by way of two terminal pivot bearings 12, thereby allowing pivoting the handle 3 along the transversal shift channels.

Moreover, return means 7 in the form of multi-leg wire springs 7 are provided, which are fixed at the housing 6 the by way of spring windings and an axis 9 guided by the spring windings and abut against the guide part 5 via the legs, in order to return it from a neutral position into this position, after manually pivoting the handle 3. Detection means are provided on a printed circuit board 8, which cooperate with the positioners mounted to the sledge, to detect the different positions predetermined by the gate 2 as a combination of a respective predetermined pivot position and predetermined longitudinal position, thereby being able to assign the positions of the handle 3 to a mode of operation of a gear of the vehicle.

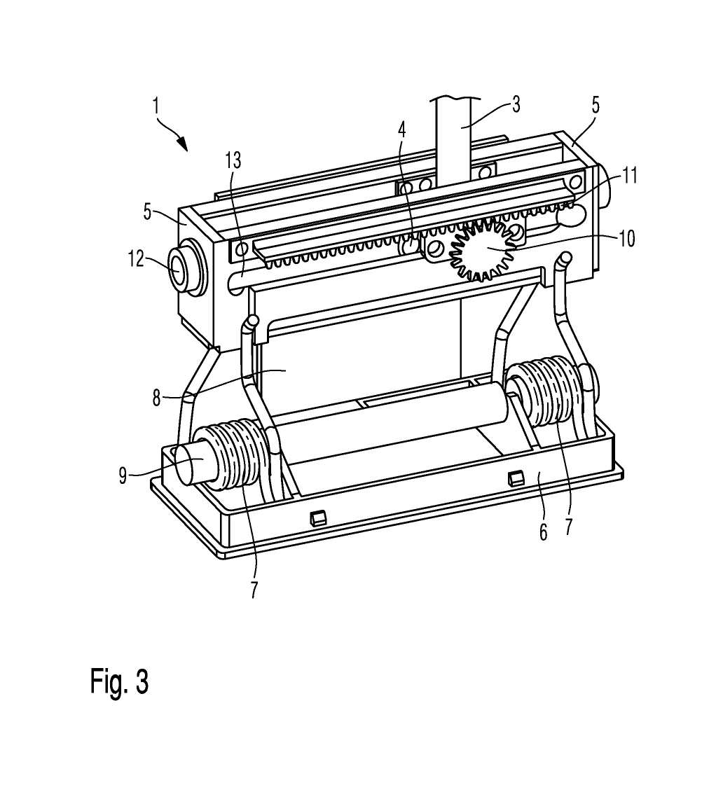

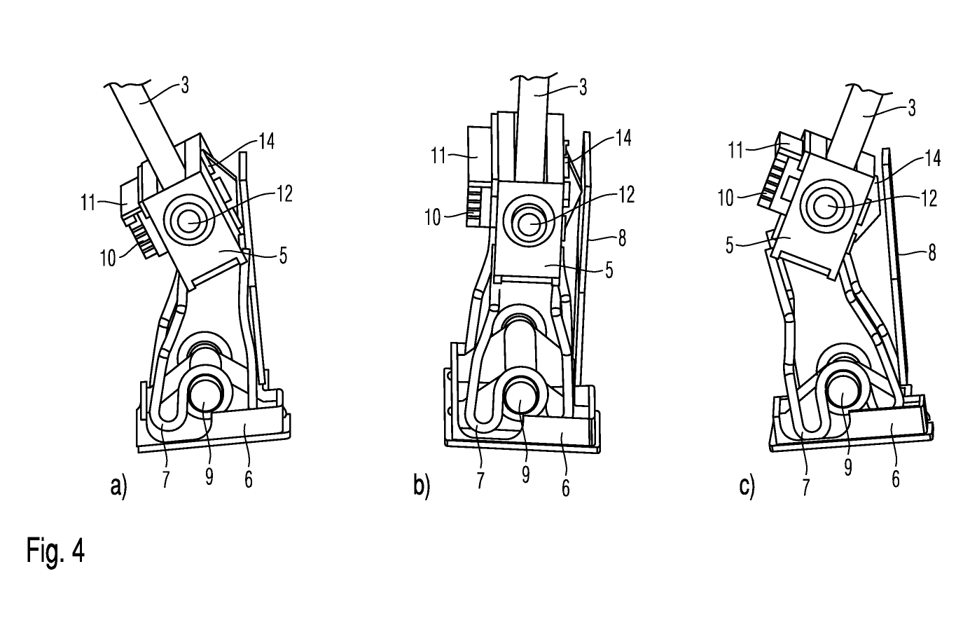

By way of FIG. 3 the design of the mechanism of the mode selection device according to the present disclosure 1 will again be illustrated. By the longitudinal displacement of the handle 3 a gear is actuated by rotating a sprocket 10 of the gear, which intermeshingly engages in a toothed rod 11 of the gear, the toothed rod being attached to the guide part 5. The sprocket 10 is associated to a rotational damper, which comprises a rotor not shown, filled with silicone oil, thereby opposing a haptically noticeable resistance to the displacement movement due to the viscosity of the silicone oil. By way of FIG. 4 different pivot positions of the handle 3 and the guide parts 5 are to be illustrated. The multi-leg springs 7 the opposite ends of which each form a leg having opposite direction of action onto the guide part 5 each provide return of the handle 3 from the pivot position shown in the FIGS. 4a and 4c into the neutral position shown in FIG. 4b. The pivot positions corresponding to the FIGS. 4a to 4c are each detected by the modified orientation of the positioners 14 in relation to the detection means arranged on the printed circuit board 8.

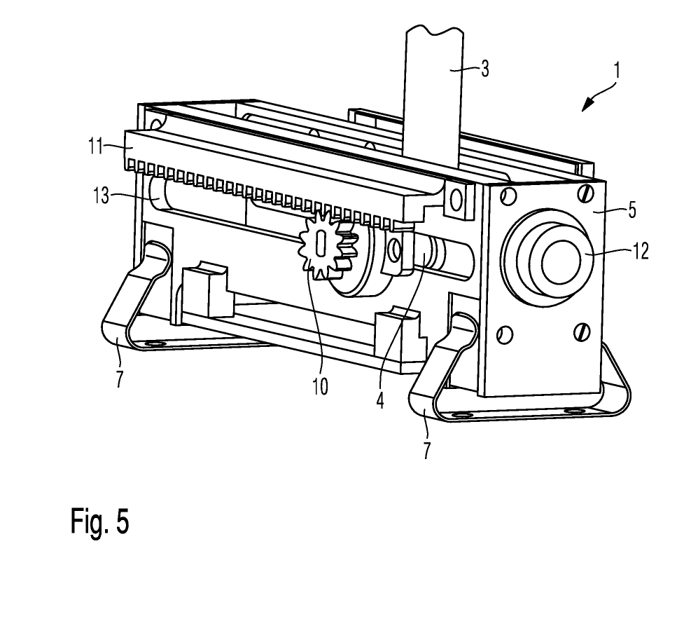

The FIG. 5 shows another embodiment of the mode selection device 1 according to the present disclosure. These basically differ from the embodiment shown in the FIGS. 1 to 4 solely by the configuration of the return means 7, which, in the further embodiment, are formed as a multi-leg leaf spring.

What is claimed is:

1. A mode selection device for a vehicle gearbox, comprising:
a guide part, a sledge, a housing and a handle attached to the sledge;
wherein the sledge is movable by the handle along a guide path of the guide part in a same adjustment direction as the respective handle is movable into predetermined longitudinal positions;
wherein the guide part is pivotably mounted on the housing around a pivot direction perpendicular to the adjustment direction, so that the handle is movable into predetermined pivot positions; and
wherein said predetermined pivot positions and longitudinal positions of the handle correspond to a predetermined mode of operation of a vehicle gear.

2. The mode selection device of claim 1, wherein the guide path is at least one of: rectilinearly and continuously bent.

3. The mode selection device of claim 1, wherein a maximally possible adjustment path corresponding to the adjustment direction is longer than a maximally possible pivot path corresponding to the pivot direction.

4. The mode selection device of claim 1, wherein a gear is provided between the sledge and the guide part, said gear driving a rotational damper.

5. The mode selection device of claim 1, comprising a gate, which defines the predetermined pivot positions and longitudinal positions.

6. The mode selection device of claim 5, wherein the gate defines several longitudinal shift channels extending in the adjustment direction, which are arranged mutually offset in the adjustment direction.

7. The mode selection device of claim 1, wherein an engaging means are provided for fixing the handle in at least one of: the predetermined adjustment positions and the pivot positions.

8. The mode selection device of claim 1, comprising a return means, in order to independently return the guide part, and thus the sledge and the handle into a neutral position after manually pivoting in the pivot direction to the opposite direction.

9. The mode selection device of claim 8, wherein the return means includes a multi-leg spring.

10. The mode selection device of claim 9, wherein the multi-leg spring is fixed at the housing and is arranged such that the legs thereof returningly act onto the guide part in two opposite directions.

11. The mode selection device of claim 8, wherein the return means include at least one pair of permanent magnets.

12. The mode selection device of claim 1, installed in a motor vehicle, especially in a traction engine for agricultural or municipal utilization or a forestry machine.
